(19) United States
(12) Patent Application Publication
(10) Pub. No.: US 2005/0158475 A1
(43) Pub. Date: Jul. 21, 2005

(54) Films and compositions

(76) Inventors: David Bell, Letchworth Garden City (GB); Neill Dutton, Cumbria (GB)

Correspondence Address: WENDEROTH, LIND & PONACK, L.L.P., 2033 K STREET N. W., SUITE 800, WASHINGTON, DC, 20006-1021, US

(21) Appl. No.: 10/826,401

(22) Filed: Apr. 19, 2004

Related U.S. Application Data
(63) Continuation of application No. 10/416,273, now abandoned.

(30) Foreign Application Priority Data
Nov. 9, 2000 (GB) 0027391.2

(51) Int. Cl. B05D 1/36; B32B 15/04; B32B 27/00; B32B 27/32

(52) U.S. Cl. 427/402; 428/500; 428/457; 525/192

(57) ABSTRACT

Therefore broadly in accordance with the invention there is provided a sheet like substrate comprising a substantially non-polar material having coated onto at least one side thereon an anchor coating to aid subsequent coating thereon of a polar coating and/or layer, characterised in that the anchor coating comprises
(a) a polymer comprising an optionally substituted α, β carboxylic acid optionally of high acid value preferably the polymer having a low T_{g};
(b) a polymer comprising an optionally unsubstituted α, β carboxylic acid optionally of low acid value preferably the polymer having a high T_{g};
(c) a cross-linker, preferably added after a period of time to a mixture of polymers (a) and (b) to cross-link the resultant coating composition and increase the T_{g} thereof. Preferably films of the invention provide directly on the anchor coating; a further polar coating or layer. Preferably (a) is a low acid imminated acrylic polymer (such as that available from Avecia under the trade name XK90); (b) is an alkyl methacrylate polymer of low acid functionally such as that available commercially from Avecia under the trade name Ucrecyl H; and (c) is an arizidine cross-linker such as the trimethyloltris(N(methylaziridinyl))propionate available from Avecia under the trade name CX100).

The present invention relates improved films and coating compositions suitable to prepare such film.

It is desirable to coat certain thermoplastic films with other coats or layers which may be incompatible with a base film made from non-polar polymers. To achieve this it is well known to provide an anchor coat which can be applied to the base film to aid adhesion of the subsequent coating(s) and/or layer(s). Films can be optionally coated on both or one sides with an anchor layer or the other side may be uncoated or covered with coats or layers which are compatible with the base film polymer.

For example anchor layers are used when certain adhesive coatings are applied to a film, as many adhesive coatings are highly polar in nature. Films coated with a pressure sensitive adhesive are particularly useful as labels. Such films are attached to a release liner before use to form a laminated structure for use in a labelling process. The label film can be readily dispensed in a labelling machine onto an article such as a bottle. An anchor coat on the film more firmly attaches the pressure sensitive adhesive to the label film so that during dispensing of the label, the label film (with adhesive layer attached) separates cleanly from the release liner so the label can then be fixed by pressure onto the article to be labelled. Advantageously use of an anchor layer of the film may allow the label to be re-positionable on the article to which it is to be attached.

Films coated on two sides are known where for example it is desired to print the label on one side (top side) and apply a pressure sensitive adhesive and/or metal coating to the other side (reverse side). Thus preferred label films are often coated on the top side one side with a coating which enhances ink adhesion to provide a printable surface, the anchor layer being applied to the reverse side.

Such two side coated films are well known and for example are described in WO 97/44187 (Mobil) where the adhesive anchor layer and ink receptive layer are different coating compositions.

It may also be desirable to coat films with a metallised layer (such as aluminium) to provide desirable aesthetic and/or barrier properties to the film. However because of their high polarity such metallised coats and/or layers are difficult to adhere to a film made from a non-polar polymer. Therefore an anchor coating is required to promote good adhesion. Once metallised a film can be used without further coating or can be coated with a pressure sensitive adhesive layer for example for use as a label as described above. Note that if the adhesive is applied directly to the metal layer an anchor layer will not normally be needed due to the already highly polar nature of the metallised surface.

Although the use of anchor layers to coat both one sided and two sided films are well known, the conventional coatings used as anchor layers have been found to be unsatisfactory in some respects in particular being unstable at high temperatures such that their anchoring properties are impaired. For example metallised films with such conventional anchor coats when subject to high temperatures can separate from the base film causing undesirable changes in appearance and properties in the film.

One well known anchor coating comprises a conventional commercially available high acid imminated acrylic polymer (such as that available from Avecia under the trade name XK90). When films are metallised onto such a coating, the films have been found to exhibit poor performance when the film is subjected to prolonged exposure to temperatures above about 40° C. At these temperatures then appearance of such metallised films rapidly deteriorates showing the following sequence of changes. Firstly the films shows signs of discoloration manifesting as a Newtonian ring fault on the metallised surface (analogous to a oil drop on water) where variable colours are seen in concentric rings depending on the orientation of the film surface with respect to the incident light source. Then blemishes are seen shaped like comets which may be a function of an increased sensitivity of the film to the impression rolls used during film processing. Coating streaks become visible so that the metal looks like it has been applied by a paintbrush. Finally differentiation can been where the parts of metal coating become detached from the underlying film. These manifest as random dark areas on the metallised coat, ranging in size from a few millimetres to a few centimetres. They appear as curves, straight lines and/or random shapes similar to Chinese symbols.

Therefore it is an object of the invention to provide films coated with an anchor layer (and optionally provided with a metallised layer and/or adhesive coat directly thereon) which act to solve some or all of these previously mentioned problems.

Therefore broadly in accordance with the invention there is provided a sheet like substrate comprising a substantially non-polar material having coated onto at least one side thereon an anchor coating to aid subsequent coating thereon of a polar coating and/or layer, characterised in that the anchor coating comprises
(a) a polymer comprising an optionally substituted α, β carboxylic acid optionally of high acid value preferably the polymer having a low T_{g};
(b) a polymer comprising an optionally unsubstituted α, β carboxylic acid optionally of low acid value preferably the polymer having a high T_{g};
(c) a cross-linker, preferably added after a period of time to a mixture of polymers (a) and (b) to cross-link the resultant coating composition and increase the T_{g} thereof.

Preferably films of the invention provide directly on the anchor coating; a further polar coating or layer.

More preferably the polar coating is selected from: a pressure sensitive adhesive and/or a metal.

Most preferably the polar coating is a metal layer for example aluminium.

In another aspect of the invention there is provided a sheet like substrate comprising a substantially non-polar material having coated onto at least one side thereon an anchor coating to aid subsequent coating thereon of a polar coating and/or layer, characterised in that the anchor coating comprises
(a) a conventional commercially available high acid imminated acrylic polymer (such as that available from Avecia under the trade name XK90) advantageously in an amount of about 76% by weight of the dry coat.
(b) an alkyl methacrylate polymer and/or mixtures thereof optionally of low acid functionally and/or T_{g} of about 105° C.; preferably a methyl methacrylate and/or ethyl methacrylate; more preferably a methyl methacrylate such as that available commercially from Avecia under the trade name Ucrecyl H; most preferably in an amount of about 20% by weight of the dry coating.
(c) an arizidine cross-linker in an effective amount, preferably a trimethyloltris(N(methylaziridinyl))propionate (such as that available from Avecia under the trade name CX100), more preferably in an amount of about 4% by weight of the dry coating.
   Cross-Linkers

The anchor coat compositions of the invention may preferably be crosslinked for example by adding a crosslinker to the dispersion at, or shortly before, the time it is applied to a substrate and dried. Crosslinking may be accomplished with conventional dispersible polyisocyanate crosslinkers. Optimal cross-linking performance requires a relatively high level of terminal primary or secondary amine groups in the polyurethane compositions of the invention and generally, the more amine used, the more likely it is that the pot-life of the composition will be reduced after addition of the cross-linker. Therefore, preferred cross-linkers are those reactive at room temperature, such as polyfunctional aziridine compounds, zinc ammonium carbonate, zirconium carbonate, polyfunctional carbodiimide compounds and/or oxirane (preferably epoxy) compounds.

Arizidine are trifunctional amine compounds which may be derived from ethyleneimine. Effective arizidines may be represented by Formula 1: 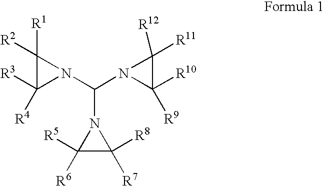
where R¹ to R¹² independently represent any effective optionally substituted organo group.

A preferred aziridine is trimethylol-tris(N(methylaziridinyl))propionate available from Avecia under the trade name CX100).

The term “oxirane” is understood to mean a compound or polymer comprising at least one 3 or 4 member cycloalkyl ether ring, that is to say at an epoxy or an oxetanyl radical or compound.

The term “epoxy” is understood to mean a compound or radical of general formula: 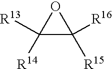
where R¹³ to R¹⁶ independently represent any effective optionally substituted organo group.

The term “oxetanyl” is understood to mean a compound or radical of general formula: 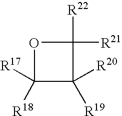
where R¹⁷ to R²² independently represent any effective optionally substituted organo group.

Preferred epoxy functional polymers are epoxy—modified bisphenol A/epichlorohidrin epoxy resins, for example those resins have the following properties: 65% solids; epoxy group content (solid resin) mmol/kg 4650-5130, epoxy molar mass (g of solid resin containing 1 g equivalent of epoxy) 195-215 g.

The properties of a coating can be altered significantly when the cross-linking function is optimised. For example when unformulated, a acrylic polymer (such as that available commercially from Avecia under the trade name XK90) provides a coating with good adhesion to polypropylene and good anchorage for inks and adhesives, but it does not have resistance to water, although when formulated water resistance can be achieved using a zirconium cross linker in conjunction with an isocyanate primer. A variety of optional materials have been tested, including melamines, silanes, aziridines and single component isocyanates. During testing (see Examples) became clear that the preferred single component cross-linker is a carbodiimide preferably present in an amount by dry weight of the total formulation of from about 1% to about 25%; more preferably from about 3% to about 20%; most preferably from about 4% to about 15%; for example about 5%. The carbodiimide is believed to act as a primer as well as a cross linker and an adhesion promoter.

The terms ‘optional substituent’ and/or ‘optionally substituted’ as used herein (unless followed by a list of other substituents) signifies the one or more of following groups (or substitution by these groups): carboxy, sulpho, formyl, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, halo, phosphorus, nitrogen, oxygen and/or sulphur, more preferably from hydrogen, nitrogen, oxygen and/or sulphur.

The term ‘hydrocarbo group’ as used herein is a sub-set of a organic group and denotes any univalent or multivalent moiety (optionally attached to one or more other moieties) which consists of one or more hydrogen atoms and one or more carbon atoms. Hydrocarbo groups may comprise one or more of the following groups. Hydrocarbyl groups comprise univalent groups formed by removing a hydrogen atom from a hydrocarbon. Hydrocarbylene groups comprise divalent groups formed by removing two hydrogen atoms from a hydrocarbon the free valencies of which are not engaged in a double bond. Hydrocarbylidene groups comprise divalent groups (represented by “R₂C═”) formed by removing two hydrogen atoms from the same carbon atom of a hydrocarbon, the free valencies of which are engaged in a double bond; Hydrocarbylidyne groups comprise trivalent groups (represented by “RC≡”), formed by removing three hydrogen atoms from the same carbon atom of a hydrocarbon the free valencies of which are engaged in a triple bond. Hydrocarbo groups may also comprise any saturated, unsaturated double and/or triple bonds (e.g. alkenyl, and/or alkynyl respectively) and/or aromatic groups (e.g. aryl) and where indicated may be substituted with other functional groups.

Most preferably organic groups comprise one or more of the following carbon containing moieties: alkyl, alkoxy, alkanoyl, carboxy, carbonyl, formyl and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group):

The term ‘alkyl’ or its equivalent (e.g. ‘alk’) as used herein may be readily replaced, where appropriate and unless the context clearly indicates otherwise, by terms encompassing any other hydrocarbo group such as those described herein.

Any substituent, group or moiety mentioned herein refers to a monovalent species unless otherwise stated or the context clearly indicates otherwise (e.g. an alkylene moiety may comprise a bivalent group linked two other moieties). A group which comprises a chain of three or more atoms signifies a group in which the chain wholly or in part may be linear, branched and/or form a ring (including spiro and/or fused rings). The total number of certain atoms is specified for certain substituents for example C₁₋ₘmorgano, signifies an organic group having from 1 to m carbon atoms. In any of the formulae herein if one or more ring substituents are not indicated as attached to any particular atom on the ring, the substituent may replace any hydrogen atom attached to a ring atom and may be located at any available position on the ring which is chemically suitable.

Preferably any of organic groups listed above comprise from 1 to 36 carbon atoms, more preferably from 1 to 18. It is particularly preferred that the number of carbon atoms in an organic group is from 1 to 10 inclusive.

Unless the context clearly indicates otherwise, as used herein plural forms of the terms herein are to be construed as including the singular form and vice versa.

The term ‘effective’ (for example with reference to the process, uses, products, materials, compounds, monomers, oligomers, polymer precursors and/or polymers of the present invention) will be understood to refer to those ingredients which if used in the correct manner provide the required properties to the material, compound, composition, monomer, oligomer, polymer precursor and/or polymer to which they are added and/or incorporated in any one or more of the uses and/or applications described herein. As used herein the term “suitable” denotes that a functional group is compatible with producing an effective product.

The substituents on the repeating unit may be selected to improve the compatibility of the materials with the polymers and/or resins in which they may be formulated and/or incorporated to form a flame retardant material. Thus, the size and length of the substituents may be selected to optimise the physical entanglement or interlocation with the resin or they may or may not comprise other reactive entities capable of chemically reacting and/or cross-linking with such other resins.

Certain moieties, species, groups, repeat units, compounds, oligomers, polymers, materials, mixtures, compositions and/or formulations which comprise some or all of the invention as described herein may exist as one or more stereoisomers (such as enantiomers, diastereoisomers, geometric isomers, tautomers and/or conformers), salts, zwitterions, complexes (such as chelates, clathrates, crown compounds, cyptands/cryptades, inclusion compounds, intercalation compounds, interstitial compounds, ligand complexes, non-stoichiometric complexes, organometallic complexes, π-adducts, solvates and/or hydrates); isotopically substituted forms, polymeric configurations [such as homo or copolymers, random, graft or block polymers, linear or branched polymers (e.g. star and/or side branched polymers), hyperbranched polymers and/or dendritic macromolecules (such as those of the type described in WO 93/17060), cross-linked and/or networked polymers, polymers obtainable from di and/or tri-valent repeat units, dendrimers, polymers of different tacticity (e.g. isotactic, syndiotactic or atactic polymers)]; polymorphs [such as interstitial forms, crystalline forms, amorphous forms, phases and/or solid solutions] combinations thereof where possible and/or mixtures thereof. The present invention comprises all such forms which are effective.

It is appreciated that certain features of the invention, which are for clarity described in the context of separate embodiments may also be provided in combination in a single embodiment. Conversely various features of the invention, which are for brevity, described in the context of a single embodiment, may also be provided separately or in any suitable sub-combination.

The term “comprising” as used herein will be understood to mean that the list following is non-exhaustive and may or may not include any other additional suitable items, for example one or more further feature(s), component(s), ingredient(s) and/or substituent(s) as appropriate.

Substrates

The film used in the present invention, prior to deposition of any coating or layer may be any suitable substrate, such as any well known filming material(s). Suitable filming or film materials may comprise any of the following: paper, synthetic paper, woven fabric, non-woven fabric, ceramic film, metallic fibre film, metallised film or film, metallic foil, metallic plate; cellulosic films (e.g. microbial or regenerated cellulose film), thermoplastic films; polymeric films (for example films comprising: polyolefins [e.g. polybutylene, polypropylene and/or polyethylene] polyurethanes, polyvinylhalides [e.g. PVC], polyesters [e.g. polyethylene terephthalate—PET], polyamides [e.g. nylons] and/or non-hydrocarbon polymers); and/or multilayer and/or composite films formed by any suitable combinations and/or mixtures of thereof.

Preferably the fillm comprises a cellulosic material, polymeric material and/or thermoplastic polymer, conveniently comprising polymers of low surface energy. More preferably the film comprises a homopolymer, a crystalline polymer and/or a polymer of randomly oriented amorphous non-crystalline polymer chains. Most preferably the film comprises: polyolefins [e.g. polypropylene and/or polyethylene] polyurethanes, polyvinylhalides [e.g. polyvinyl chloride (PVC),], polyesters [e.g. polyethylene terephthalate—PET], polyamides [e.g. nylons] and/or non-hydrocarbon polymers).

Conveniently the polyolefin films to be used with the present invention may comprise one or more polyolefins [e.g. polybutylene homopolymer, polypropylene homopolymer, polyethylene homopolymer (e.g. linear low-density polyethylene—LLDPE), and/or copolymer or terpolymer combinations of butylene, propylene and/or ethylene monomer(s); optionally in one or more layers]. Preferred polymers may be random and/or block polymers. The constituent polymers and/or layers in a film of the present invention may be oriented, blown, shrunk, stretched, cast, extruded, co-extruded and/or comprise any suitable mixtures and/or combinations thereof. Preferred films comprise a major proportion of polypropylene and/or an olefin block and/or random copolymer containing up to about 15% (more preferably 10%) w/w of the copolymer of at least one copolymerisable olefin (such as ethylene) and/or polyester. More preferred films comprise polypropylene homopolymer, most preferably isotactic polypropylene homopolymer. Films may optionally be crosslinked by any suitable means such as electron beam (EB) or UV crosslinking, if necessary by use of suitable additives in the film.

The definition of polyolefin, as intended herein, is a polymer assembled from a significant percentage, preferably ≧50% by weight of one or more olefinic monomers. The definition of copolymer herein, is a polymer assembled from two or more monomers. Such polymers may include, but are not limited to, polyethylene homopolymers, ethylene-α-olefin copolymers, polypropylene-α-olefin copolymers, polypropylene homopolymers, polybutylene homopolymers, polybutylene-α-olefin copolymers, butylene-propylene copolymers, butylene-ethylene copolymers, propylene-ethylene copolymers, butylene-propylene-ethylene terpolymers, ethylene-vinyl acetate copolymers, ethylene-methacrylic acid copolymers and their salts, ethylene-styrene polymers and/or blends of such polymers. The polymers may be produced by any suitable means, for example one or more of free radical polymerisation (e.g. peroxy compounds), metallocoene catalysis, coordination catalysis (e.g., Ziegler or Natta catalysts and/or variations thereof).

Polymeric resins used to produce the films of the present invention are generally commercially available in pellet form and may be melt blended or mechanically mixed by well-known methods known in the art, using commercially available equipment including tumblers, mixers and/or blenders. The resins may have other additional resins blended therewith along with well-known additives such as processing aids and/or colorants. For examples hydrocarbon resins may be added to improved the stiffness and/or barrier properties of the resultant films. Methods for producing polyolefin films are well-known and include the techniques of casting films as thin films through narrow slit dies, and blown-film techniques wherein an extruded tube of molten polymer is inflated to the desired bubble diameter and/or film thickness.

For example to produce a polymeric film the resins and additives are introduced into an extruder where the resins are melt plastified by heating and then transferred to an extrusion die for formation into a film tube. Extrusion and die temperatures will generally depend upon the particular resin being processed and suitable temperature ranges are generally known in the art or provided in technical bulletins made available by resin manufacturers. Processing temperatures may vary depending upon process parameters chosen.

A film of the present invention may be oriented by stretching at a temperature above the glass transition temperature (T_{g}) of its constituent polymer(s). The resultant oriented film may exhibit greatly improved tensile and stiffness properties. Conveniently a film comprising a propylene homopolymer is oriented at a temperature within a range of from about 145° to 165° C. Orientation may be along one axis if the film is stretched in only one direction, or may be biaxial if the film is stretched in each of two mutually perpendicular directions in the plane of the film. A biaxial oriented film may be balanced or unbalanced, where an unbalanced film has a higher degree of orientation in a preferred direction, usually the transverse direction. Conventionally the longitudinal direction (LD) is the direction in which the film passes through the machine (also known as the machine direction or MD) and the transverse direction (TD) is perpendicular to MD. Preferred films are oriented in both MD and TD.

Orientation of the film may be achieved by any suitable technique. For example in the bubble process the polypropylene film is extruded in the form of a composite tube which is subsequently quenched, reheated, and then expanded by internal gas pressure to oriented in the TD, and withdrawn, at a rate greater than that at which it is extruded, to stretch and orient it in the MD. Alternatively a flat film may be oriented by simultaneous or sequential stretching in each of two mutually perpendicular directions by means of a stenter, or by a combination of draw rolls and a stenter. A preferred oriented film comprises biaxially oriented polypropylene (known herein as BOPP), more preferably the BOPP film described in EP 0202812.

The degree to which the film substrate is stretched depends to some extent on the ultimate use for which the film is intended, but for a polypropylene film satisfactory tensile and other properties are generally developed when the film is stretched to between three and ten, preferably, seven, times its original dimensions in each of TD and MD.

After stretching, the polymeric film substrate is normally heat-set, while restrained against shrinkage or even maintained at constant dimensions, at a temperature above the T_{g} of the polymer and below its melting point. The optimum heat-setting temperature can readily be established by simple experimentation. Conveniently a polypropylene film is heat-set at temperatures in the range from about 100° C. to about 160° C. Heat-setting may be effected by conventional techniques for example by means one or more of the following: a stenter system; one or more heated rollers (e.g. as described in GB 1124886) and/or a constrained heat treatment (e.g. as described in EP 023776).

The film may comprise a major proportion of polypropylene such as isotactic polypropylene homopolymer, but also may comprise coextruded multilayer films where the polymer of at least one layer is isotactic polypropylene homopolymer, and the polymer of one or both outer layers is a surface layer polymer having different properties to the isotactic polypropylene homopolymer.

The film of the present invention may consist of only one layer, or may be multi-layered i.e. comprise a plurality of layers. The layers can be combined by lamination or co-extrusion. More preferably the film comprises at least three layers where at least one layer(s) are sandwiched between other layers such that none of such sandwiched layer(s) form either surface of the film.

Thus for example a film of the invention may comprise a three layer film where the polymer of a central or core layer comprises one polymeric material. The core layer may have a thickness of about 90 to about 98% of the total thickness of the film. The remainder of such a three layer film may comprise two outer layers of another polymeric material, with each outer layer having substantially identical thickness.

Another film of the present invention may comprise a coextruded five layer film comprising a central core layer, two layers contiguous to the central core layer and two outermost layers, where the central core layer and such contiguous layers comprise one polymeric material and the two outer layers comprise another polymeric material. Preferably the central core layer has a thickness from about 70% to about 96%, more preferably from about 76% to about 90%, of the total thickness of the film. Preferably each of such contiguous layers has substantially the same thickness, which is more preferably from about 1% to about 6%, most preferably from about 1% to about 2%, of the total thickness of the film. Preferably each outer layer has substantially the same thickness, which is more preferably from about 1% to about 6%, most preferably from about 1% to about 2%, of the total thickness of the film.

A film of the invention may also be made by lamination of two coextruded films.

One or more layers of the films of the present invention may be opaque or transparent depending on the end use of the film. Such layers may also comprise voids introduced by stretch orienting such a layer containing (optionally spherical) particles of a material higher melting than and immiscible with the layer material (e.g. if the layer comprises isotactic polypropylene homopolymer, then such particles may be, polybutylene terephthalate, as shown, for example, in U.S. Pat. No.4,632,869 and U.S. Pat. No. 4,720,716). Preferably such particles may comprise natural fibre (such as cellulosic fibre, wool pulp, cotton linters, vegetable fibre, hemp and/or sisial), synthetic fibre (such as viscose, polyester, and/or nylon) and/or organic and/or inorganic particles of any shape such as spherical and/or amorphous particles (e.g. calcium carbonate, ground cellulose, cellulose spheres, amorphous polysaccharides, starch, chitin and/or super absorbent polyacrylate powder).

Multiple-layer films of the invention may be prepared in a range of thicknesses governed primarily by the ultimate application for which a particular film is to be employed. For general use films, having a mean thickness from about 2.5 μm to about 150 μm, preferably from about 4 μm to about 100 μm are suitable. For certain applications, such as packaging, more preferred films have a mean thickness of from about 8 μm to 50 μm, most preferably from about 10 μm to about 40 μm.

If desired, before coating a film of the present invention (e.g. with PVdX or any other coating or layer) may be subjected to a chemical or physical surface-modifying treatment to insure that the coating will better adhere to the film thereby reducing the possibility of the coating peeling or being stripped from the film. Known prior art techniques for surface pre-treatment prior to coating comprise, for example: film chlorination, i.e., exposure of the film to gaseous chlorine; treatment with oxidising agents such as chromic acid, hot air or steam treatment; flame treatment and the like. A preferred treatment, because of its simplicity and effectiveness, is the so-called electronic treatment in which the film is passed between a pair of spaced electrodes to expose the film surface to a high voltage electrical stress accompanied by corona discharge.

Optionally if an even adhesion of the coating is desired an intermediate continuous coating of primer medium can applied to a film surface treated by any of the methods described herein. Primer materials may comprise titanates and poly(ethylene imine) and may be applied by as conventional solution coatings [such as poly(ethylene imine) applied as either an aqueous or organic solvent solution, e.g. in ethanol comprising about 0.5 wt. % of the imine]. Another primer medium comprises the interpolymerised condensation acrylic resins prepared in the presence of a C₁₋₆alkanol as described in either: GB 1134876 (condensing a monoaldehyde with an interpolymer of acrylamide or methacrylamide with at least one other unsaturated monomer); or in GB 1174328 (condensing a monoaldehyde with acrylamide or methacrylamide, and subsequently interpolymerising the condensation product with at least one other unsaturated monomer).

One or more of the layers of a films of the invention (such as films) may conveniently contain any additives added within the film and/or as part of a coating on to the film conventionally employed in the manufacture of films, and such additives and/or coatings may be added for more than one effect and/or for similar purposes. Such additives and/or coatings may be selected from one or more of the following, mixtures thereof and/or combinations thereof: dyes; pigments, colorants; metallised and/or pseudo-metallised coatings; lubricants, anti-oxidants, anti-static agents; surface-active agents, stiffening aids, gloss-improvers, prodegradants, UV attenuating materials (e.g. UV light stabilisers); sealability additives;, tackifiers, anti-blocking agents, additives to improve ink adhesion and/or printability, further cross-linking agents (such as melamine formaldehyde resin); jaw release aids, adhesive layer (e.g. a pressure sensitive adhesive); an adhesive release layer (e.g. for use as the backing material in the peel plate method for making labels); and/or a barrier layer and/or ingredients to achieve or improve the impermeablity of the film for example to moisture and/or oxygen (such as vinylidene halide homo or copolymers e.g. PvDC or PvDF which may be in the form of a stabilised dispersion optionally stabilised with anionic or cationic surfactants). It will be appreciated that a plurality of the preceding properties may be achieved by one or more additives and/or coatings which exhibit two or more of these affects.

Further coating ingredients comprise those to reduce coefficient of friction (COF) such as: silica and/or a terpolymer described in U.S. Pat. No. 3,753,769 which comprises from about 2% to about 15% w/w of acrylic or methacrylic acid, from about 10% to about 80% w/w of methyl or ethyl acrylate, and from about 10% to about 80% w/w of methyl methacrylate, together with colloidal silica and microcrystalline wax such as beeswax, paraffin wax and/or carnauba wax.

Still further additives comprise slip aids such as hot slip aids or cold slip aids which improve the ability of a film to satisfactorily slide across surfaces at about room temperature for example micro-crystalline wax. Preferably the wax is present in the coating in an amount from about 0.5% to about 5.0% w/w, more preferably from about 1.5% to about 2.5% w/w. The wax particles may have an average size conveniently from about 0.1 μm to 0.6 μm, more conveniently from about 0.12 μm to about 0.30 μm.

Yet further additives comprise conventional inert particulate additives, preferably having an average particle size of from about 0.2 μm to about 4.5 μm, more preferably from about 0.7 μm to about 3.0 μm. Decreasing the particle size improves the gloss of the film. The amount of additive, preferably spherical, incorporated into the or each layer is desirably in excess of about 0.05%, preferably from about 0.1% to about 0.5%, for example, about 0.15%, by weight. Suitable inert particulate additives may comprise an inorganic or an organic additive, or a mixture of two or more such additives. Suitable particulate inorganic additives include inorganic fillers such as talc, and particularly metal or metalloid oxides, such as alumina and silica. Solid or hollow, glass or ceramic micro-beads or micro-spheres may also be employed. A suitable organic additive comprises particles, preferably spherical, of an acrylic and/or methacrylic resin comprising a polymer or copolymer of acrylic acid and/or methacrylic acid and/or a C₁₋₆ester thereof. Such resins may be cross-linked, for example by the inclusion therein of a cross-linking agent, such as a methylated melamine-formaldehyde resin. Promotion of cross-linking may be assisted by the provision of appropriate functional groupings, such as hydroxy, carboxy and amido groupings, in the acrylic and/or methacrylic polymer.

Yet still further additives comprise fumed silica for the purpose of further reducing the tack of the coating at room temperature. The fumed silica is composed of particles which are agglomerations of smaller particles and which have an average particle size of, for example, from about 2 μm to about 9 μm, preferably from about 3 μm to about 5 μm, and is present in the coating in an amount, for example, from about 0.1% to about 2.0% by weight, preferably about 0.2% to about 0.4% by weight.

It is contemplated that in some instances, the additives used in the present invention should have the additional benefit of aiding or enhancing the properties of other conventional additives used in the film such as those listed herein.

Some or all of the desired additives listed above may be added together as a composition to coat the film of the present invention and/or form a new layer which may itself be coated (i.e. form one of the inner layers of a final multi-layered film) and/or may form the outer or surface layer of the film. Alternatively some or all of the preceding additives may be added separately and/or incorporated directly into the bulk of the film optionally during and/or prior to the film formation (e.g. incorporated as part of the original polymer composition by any suitable means for example compounding, blending and/or injection) and thus may or may not form layers or coatings as such.

Formation of a film of the invention (optionally oriented and optionally heat-set as described herein) which comprises one or more additional layers and/or coatings is conveniently effected by any of the laminating or coating techniques well known to those skilled in the art.

A film of the invention may also be coated with one or more of the additives described herein using conventional coating techniques from a solution or dispersion of the additive in a suitable solvent or dispersant. An aqueous latex, (for example prepared by polymerising polymer precursors of a polymeric additive) in an aqueous emulsion in the presence of an appropriate emulsifying agent is a preferred medium from which a polymeric additive or coating may be applied.

Such coatings may be applied to the second surface of the film (i.e. that surface other than that to which the high resistance printable coating of the invention is applied), to either surface or to both surfaces. The, or each, coating may be applied sequentially, simultaneously and/or subsequently to any or all other coatings.

A coating composition may be applied to the treated surface of film (such as the polymer film) in any suitable manner such as by gravure printing, roll coating, rod coating, dipping and/or spraying. Solvents, diluents and adjuvants may also be used in these processes as desired. The excess liquid (e.g. aqueous solution) can be removed by any suitable means such as squeeze rolls and/or doctor knives. The coating composition will ordinarily be applied in such an amount that there will be deposited following drying, a smooth, evenly distributed layer of suitable thickness. In general, the thickness of the applied coating is such that it is sufficient to impart the desired characteristics to the substrate film. Once applied to the film a coating may be subsequently dried by hot air, radiant heat or by any other suitable means to provide a film of the present invention with the other desired properties (such as a non-water soluble, optionally clear, adherent, glossy coated film useful, for example, in labelling and/or graphic arts applications).

It would also be possible to use more than one of the above methods for one or more of the additives or components thereof described herein for example one or more of the components may be incorporated into the resin prior to making the film and the one or more others may be coated onto the surface

Further aspects of the present invention also comprise:
packaging for an article, the packaging comprising a film of the invention as described herein;
an article packaged with said packaging;
a label and/or graphic art display comprising a film of the invention as described herein; and/or
an article comprising said label and/or said graphic art display.

A further aspect of the present invention is the coating composition used to coat the films described herein and related aspects of such compositions. It is readily apparent that all preferred features, embodiments and/or examples described herein relating to films of the invention apply analogously to all the inventions described herein such as for example to the compositions, agents, uses thereof, and methods for making them described below.

Thus broadly there is provided a composition as described herein effective for applying as a coating to produce a film having the advantageous properties described herein.

Still further aspects of the present invention comprise:
a method of coating a film with a composition of the invention as described herein;
use of a composition of the invention as described herein for the purpose of coating a film to provide at least one improved property to a film, preferably such propert(ies) being selected from: improved heat resistance and/or improved adhesion.

In another aspect of the invention comprises compositions of the invention and a process of preparing them in which the composition further comprises a means to delay or inhibit action of the cross-linker until the composition has been coated onto a film surface. This allows for increased pot life and means that the process can cope with interruptions that can cause the formulation to be in solution for several hours.

For example a pH of a coating composition of the invention may be around 8.6 to 8.8. If the pH of the formulation is increase to around 9.2 or 9.3 (e.g. by adding ammonia) this will inhibit the activation of the aziridine crosslinker when present in the wet formulation.

Viscosity testing may be carried out characterise the nature of the crosslinking mechanism and the improvement of pot life in such coating compositions.

Yet still further aspects of the invention and preferred features thereof are given in the claims.

The invention is further illustrated by reference to the following non-limiting Examples. which were tested for various properties. The principle tests used herein are described below.

In the Examples herein the coatings of the present invention were all coated onto a conventional OPP film which was prepared by any suitable well known method such as that described below.

Preparation of Uncoated OPP Film

From a triple channel annular die were coextruded a propylene homopolymer and a composition to form a polypropylene. The coated polypropylene tube was cooled by passage over a mandrel within the tube, and externally quenched by passage through a water bath surrounding the mandrel, heated to stretching temperature, expanded by internal gas pressure, and withdrawn from the expansion zone at a rate greater than that at which it was fed thereto, so that the tube was stretched to seven times its original dimensions in both the direction of extrusion and in a direction transverse thereto. The stretched tubular film was then opened out to form flat film which was subsequently heat-set at a temperature of 120° C. on a matt-surfaced roller heat-setter of the kind described in GB-A-1124886. Discharge treatment of the heat-set film was effected by a single aluminium rod electrode extending across the entire width of the film, and connected to a Sherman GT60, 6 kilowatts, solid state corona treater, operating at 2 amps.

Coating Methods

Coated films of the invention and comparative examples were prepared by coating a base film with the relevant coating compositions. Each of the films prepared and tested herein by the applicant have a pre-coat of a conventional primer applied (using yellow bar no 1—see Table 1) to the corona treated surface of the base film so the subsequently applied coatings would better adhere to the film surface.

Details of the film and coating used for each example are given below and in the Tables. The films were coated using any suitable method such as a gravure printer or a bar coater such as model No K303 RK Multicoater.

A bar coater has a bar coating head having a spiral wire around the outside of the bar which acts to dispense a coating composition onto a substrate surface. Selecting different bars will alter the coating thickness. The characteristics of the bars that can be used to prepare the examples herein are as follows.

TABLE 1
(coating bars)

| Standard coating | Wet film | |
|---|---|---|
| bar for K303 | deposit | Wire size |
| No 1 (Yellow) | 0.00025″ = | 0.003″ |
| | 6 micron | (0.08 mm) |
| No 2 (Red) | 0.0005″ = | 0.006″ |
| | 12 micron | (0.16 mm) |
| No 2 (Red) | 0.0005″ = | 0.006″ |
| | 12 micron | (0.16 mm) |
| No 3 (Green) | 0.001″ = | 0.012″ |
| | 24 micron | (0.31 mm) |
| No 4 (Black) | 0.0015″ = | 0.020″ |
| | 40 micron | (0.51 mm) |

If a gravure coater is used to apply a coat it is possible that the coating could be applied in streaks because it does not wetting out properly. To overcome such “low out” problems a wetting agent may be added to the liquid aqueous compositions used to apply the coats of the present invention. Any suitable wetting agents may be added in any suitable amount. For example alkyl polyethylene glycols such as that available commercially under the trade name Lutensol A8. Suitable amounts of wetting agent may comprise about 0.5% by dry weight the coating.

### EXAMPLES AND TEST RESULTS

Films were prepared in which various anchor coatings were applied to one side of the film and then the film was metallised on the coated sided. The coatings were applied (using the methods described herein) in a liquid dispersion at 20% solids to give a final dry coat weight of about 1 gm⁻². However its is possible to use coating formulations with less solids (say about 15% solids) to achieved a range of ‘dry’ coat weights for example from about 0.5 gm⁻² up to about 1 gsm⁻². It has been found that there is not any real benefit of coating any thicker and it is preferred to provide thinner anchor coats simply for reasons of economy.

Each of the test films were in the first instance produced on a draw down machine at a dry coat weight of 1 gm⁻² and dried in an oven at 120° C. for 1 minute. It was also possible to produce similar films using a pilot coater where the oven temperature was set to 120° C. but residence would only be a couple of seconds and furthermore completed a trial on the plant where the residence time was about 6 seconds.

The films coated with the various anchor coats were metallised. The metalliser used was an Edwards Coating System E306A vacuum laboratory metalliser. This machine has the capability of doing A4 sheets. All sheets metallised were first aged 24 hours to allow the crosslinking to be all but complete before metallisation took place.

These metallised films were subjected to various temperatures as described below and the properties of the metallised coat was evaluated as described herein.

The results are given in the following table. In particular the strength and cohesiveness of adhesion of the metal coat was assessed visually, both immediately after metallisation and also after some time had elapsed with the film held at various temperatures as given in the table.

TABLE 2

| | | | Surface energy | |
|---|---|---|---|---|
| | | | (mN)m⁻¹ | |
| | | | Disper- | |
| Example | Temp/RH | Adhesion result | sive | Polar |
| Uncoated substrate | | | | |
| Polymethyl | | Not applicable | 35.9 | 4.3 |
| methacrylate | | | | |
| (PMMA) | | | | |
| PVdC | | Not applicable | 42.0 | 3.0 |
| PET | | Not applicable | 43.2 | 4.1 |
| PP | | Not applicable | 30.2 | — |

PP film coated with comparative anchor coats

| | | | | |
|---|---|---|---|---|
| Comp 1 = | 90° C./6% | Initial adhesion | 50.23 | 6.179 |
| XK90 (100%) | | passed, failed after | | |
| | | 25 s. | | |
| Comp 2 = XK 90 | 90° C./8% | Initial adhesion | 52.95 | 8.04 |
| (96%) + 4% CX100 | | passed, Little to no | | |
| | | effect after 1 hr | | |
| Comp 3 = 96% XK | 95° C./− | Initial adhesion | — | — |
| 90 + 4% CX100 | | passed, first signs of | | |
| | | failure after 49 mins. | | |
| Comp 4 = XK90 + | 90° C./− | Initial adhesion | 43.3 | 2.129 |
| Ucecryl H | | borderline, complete | | |
| (50%:50%) | | failure after 44 mins. | | |
| Comp 5 = XK90 + | 90° C. | Initial adhesion | 43.75 | 6.917 |
| Ucecryl H | | passed, complete | | |
| (75%:25%) | | failure after 50 mins. | | |

PP film coated with anchor coat of present invention

| | | | | |
|---|---|---|---|---|
| Ex 1 = XK 90 + | 95° C. | Initial adhesion | 43.4 | 6.546 |
| 20% Ucecryl H + | | passed, after 24 hrs | | |
| 4% CX100 | | no obvious effects. | | |

In the Table 2 above all percentages are by weight of the dry coating and RH denotes relative humidity during the test if known.

The test method used to measure the surface tension is achieved by measuring the contact angle with two solutions namely water and diiodomethane. It is measured in a conventional manner using a FTA 200 contact angle machine produced by FTA and available through Camtel.

In Table 2:
PP denotes a conventional film of biaxially oriented polypropylene used as the substrate for the tests of coatings (Comp 1 to 5 and Example 1).
XK90 denotes a conventional high acid imminated acrylic polymer available commercially from Avecia under that trade designation XK90;
Ucecryl H denotes an almost pure methyl methacrylate polymer with a trace level of ethyl acrylate and a low acid functionality with a Tg in the region of 105° C. available commercially from UCB Chemicals under that trade designation Ucecryl H;
CX100 denotes the aziridine crosslinker trimethylol tris-N(methylaziridinyl) propionate available commercially from Avecia under that trade designation XK90;

Thus it can be seen from the table herein that a metallised film using the anchor coat of the present invention is less susceptible to adhesion problems at higher temperature.

Films of the invention show a marked improvement in the thermal stability of the film. Films coated as Example 1 herein were put into an oven for twenty days at 60° C. and no sign of the deterioration of the metal appearance was noted.

Films of the invention and prior art were also subjected to a pasteurisation test as follows. A metal coat was applied over the anchor coating (as described herein) and then an conventional pressure sensitive adhesive was applied on top of the metal layer in the normal manner. The resultant metallised film was then applied to a bottle as would happen on a bottling line. The labelled bottle was then held in water bath at 95° C. for 30 minutes.

After this test all films (Comp 1 to 5) using prior art anchor coatings show clear signs of deterioration in the metal coat on the label, however a label made with the coating of the invention (Example 1) remained glossy and unaffected. In order to allow for complete cross-linking the pasteurisation test is not performed until the film of the invention had been left to age. The optimum aging time is preferably at least 24 hours, more preferably at least 3 days.

The aging of the film can be seen by measuring the surface tension of the coatings. When initially produced the surface tension of Example 1 was measured at polar 6.546 (mN)m⁻¹ and dispersive 43.4 (mN)m⁻¹ (see Table 2).

After 1 day (after the crosslinking had largely been completed) the surface tension of a film made as Example 1 (using BOPP film of different thicknesses) was found to be

For a 52 micron thick base film
polar 16.45 (mN)m⁻¹ and dispersive 39.72 (mN)m⁻¹

For a 60 micron thick base film
polar 15.61 (mN)m⁻¹ dispersive 42.55 (mN)m⁻¹

Samples with the same coating were then aged for longer on a 50 micron base film and the results were
1 week old—polar 17.81, (mN)m⁻¹ dispersive 38.58 (mN)m⁻¹
2 week old—polar 15.62, (mN)m⁻¹ dispersive 40.76 (mN)m⁻¹

When we consider the comparative levels of other materials we can see that this coating has a significant advantage in adhesives application Although the dispersive value is in line with what one would expect from a hardened acrylic coating the polar value increase significantly as the crosslinking mechanism completes.

1-29. (canceled)

30. A sheet like substrate comprising a substantially non-polar material having coated onto at least one side thereon an anchor coating to aid subsequent coating thereon of a polar coating and/or layer, characterised in that the anchor coating comprises
(a) a polymer comprising an optionally substituted α,β carboxylic acid optionally of high acid value preferably the polymer having a low T_{g};
(b) a polymer comprising an optionally unsubstituted α,β carboxylic acid optionally of low acid value preferably the polymer having a high T_{g};
(c) a cross-linker, preferably added after a period of time to a mixture of polymers (a) and (b) to cross-link the resultant coating composition and increase the T_{g} thereof.

31. The sheet as claimed in claim 30, in which the polar coating or layer is selected from: a pressure sensitive adhesive and/or a metal.

32. The sheet as claimed in claim 30, in which the polar coating is a metal layer.

33. The sheet as claimed in claim 30 in which the polar coating is aluminum.

34. The sheet as claimed in claim 30 in which component (a) comprises a high acid imminated acrylic polymer.

35. The sheet as claimed in claim 30 in which component (a) is present in an amount from about 50% to about 90% by weight of the dry coat.

36. A sheet as claimed in claim 30 in which component (a) is present in an amount from about 70% to about 80% by weight of the dry coat.

37. The sheet as claimed in claim 30 in which component (b) comprises an alkyl methacrylate polymer.

38. The sheet as claimed in claim 30 in which component (a) is present in an amount from about 5% to about 50% by weight of the dry coat.

39. The sheet as claimed in claim 30 in which component (a) is present in an amount from about 10% to about 30% by weight of the dry coat.

40. The sheet as claimed in claim 30 in which component (c) comprises an aziridine cross-linker.

41. The sheet as claimed in claim 30 in which component (c) comprises trimethylol-tris(N(methylaziridinyl))propionate.

42. The sheet as claimed in claim 30 in which component (c) is present in an amount from about 0.1% to about 20% by weight of the dry coat.

43. The sheet as claimed in claim 30 in which component (c) is present in an amount from about 1% to about 10% by weight of the dry coat.

44. An anchor coating composition comprising
(a) a polymer comprising an optionally substituted α,β carboxylic acid optionally of high acid value preferably the polymer having a low T_{g};
(b) a polymer comprising an optionally unsubstituted α,β carboxylic acid optionally of low acid value preferably the polymer having a high T_{g};
(c) a cross-linker, preferably added after a period of time to a mixture of polymers (a) and (b) to cross-link the resultant coating composition and increase the T_{g} thereof.

45. The anchor coating composition comprising components (a), (b) and (c) as claimed in claim 44 plus a liquid carrier.

46. The anchor coating composition as claimed in 45, in which the liquid carrier is water.

47. The anchor coating composition as claimed in claim 45 which further comprises a wetting agent.

48. The anchor coating composition as claimed in claim 45 which further comprises a means to inhibit the cross-linking component (c).

49. A method for coating at least one side of a substantially planar self supporting sheet, the method comprising the steps of:
(a) optionally treating the sheet surface (optionally by primer coat and/or corona discharge) to better receive a coating;
(b) preparing a coating composition as claimed in claim 44;
(c) applying and fixing said composition to at least one surface of the sheet to form a coating thereon;
(d) optionally drying the coating on the sheet to remove excess liquid.

50. A method for coating at least one side of a substantially planar self supporting sheet, the method comprising the steps of:
(a) optionally treating the sheet surface (optionally by primer coat and/or corona discharge) to better receive a coating;
(b) preparing a coating composition as claimed in claim 48;
(c1) applying and fixing said formulation to at least one surface of the sheet to form a coating thereon;
(c2) just before, sequentially, or simultaneously with step (c1) deactivating the inhibition means to allow cross-linking; and
(d) optionally drying the coating on the sheet to remove excess liquid.

51. The method as claimed in claim 50, in which step (c2) comprises a change in pH.

52. The method as claimed in any of claims 49 to 51, which comprises the further steps of:
(e) waiting until cross-linking has substantially been completed; and then
(f) applying a further coating onto the anchor composition.

53. The method as claimed in claim 49 or 50, in which a further coat comprises an adhesive (optionally pressure-sensitive) and/or a metal layer (optionally aluminum).

54. The coated sheet obtained and/or obtainable by a method claimed in any one of claims 49 or 50.

55. The sheet according to any of claim 30, in which the sheet comprises a cellulosic material, polymeric material and/or thermoplastic polymer.

56. The sheet according to claim 55, in which the sheet comprises a polyolefin, polyurethane, polyester, polyamides and/or non-hydrocarbon polymer and which is optionally oriented in at least one direction.

57. Packaging for an article, the packaging comprising the sheet as claimed in claim 30.

58. An article packaged with packaging as claimed in claim 57.

59. A label and/or graphic art display comprising a sheet as claimed in claim 30.

60. An article comprising a label and/or graphic art display as claimed in claim 59.
